(19) United States
(12) Patent Application Publication
(10) Pub. No.: US 2023/0121322 A1
(43) Pub. Date: Apr. 20, 2023

(54) SECONDARY POOL FILTER DEVICE

(71) Applicant: Matija Mamela, Phoenix, AZ (US)

(72) Inventor: Matija Mamela, Phoenix, AZ (US)

(21) Appl. No.: 17/867,686

(22) Filed: Jul. 19, 2022

Related U.S. Application Data
(60) Provisional application No. 63/360,591, filed on Oct. 18, 2021.

(51) Int. Cl. E04H 4/12; B01D 29/00

(52) U.S. Cl. CPC E04H 4/1245; B01D 29/0018

(57) ABSTRACT

A secondary pool filter device; the secondary pool filter device includes a secondary filter configured to fit over and removably attach to a return jet of a swimming pool and provide secondary filtration for swimming pools. The secondary filter includes a filter pad and a filter sleeve. The filter pad encases a mesh screen and includes a plurality of layers of filtering material. The filter sleeve includes an open end, a closed end, and a cinch tie for removably securing the secondary filter to a return jet. The open end is configured to receive the filter pad for hosting the filter pad within the filter sleeve. The secondary pool filter device helps maintain cleaner water in swimming pools.

### CROSS-REFERENCE TO RELATED APPLICATION(S)

The present application is related to and claims priority to U.S. Provisional Patent Application No. 63/360,591 filed Oct. 19, 2021, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of water filters of existing art and more specifically relates to pool water filter devices.

### RELATED ART

We go swimming not just for recreation, but also for health. We swim in our own backyards in our own above-ground pools not just for convenience, but also to escape the dirty water in lakes and oceans. This is why above ground pools are popular, with approximately 170,000 new units being sold every year to a market that already has over 4 million above-ground pools. Unfortunately, though, swimming pool water can be just as dirty, which can defeat our goals of healthy exercise and recreation. That dirtiness in pool water can lead to illness, which further defeats those goals. Even worse, incidents of sickness derived from pool water are growing in frequency. Ordinary traditional pool filters may not be effective all by themselves.

Consider this, 17 percent of the population openly admits they pee in the pool. Also, dirt, leaves and other unwanted items quickly decompose, which generates undesirable bacteria, along with mold and algae growing on the floors and walls of swimming pools. As a result of these shortcomings, disease-causing germs, including cryptosporidium, giardia and hepatitis A, are frequently found in pool water. The above-mentioned are chlorine tolerant, too which is concerning. This leaves swimmers at high risk of illness, especially gastroenteritis. These risks are very common, too. If health inspections were done, over half of U.S. pools wouldn't pass, says the U.S. Centers for Disease Control and Prevention, and over 10 percent would be immediately shut down due to high risks. The CDC knows this from results of testing hotel pools, which are usually maintained with higher frequency than home pools are. The risks are also growing. Reports show annual increases of 13 percent in illnesses derived from infected pool water in recent years. A suitable solution is desired to provide additional filtration needed to allow consumers to achieve their fun and healthy swimming goals.

U.S. Pat. No. 10,435,902 to Leonard Ray Taylor relates to a portable pool filter system. The described portable pool filter system is fully immersible and self-contained. Water is suction fed through the filter before entering the pump and being discharged. The device decontaminates water from all contaminations to include algae, iron, red clay, and oils.

### SUMMARY OF THE INVENTION

In view of the foregoing disadvantages inherent in the known pool water filter device art, the present disclosure provides a novel secondary pool filter device. The general purpose of the present disclosure, which will be described subsequently in greater detail, is to provide a secondary pool filter device that may be attached to water jets of above-ground pools and capture any dirt, debris, particles, algae, bacteria, and pathogens that are not trapped by a primary pump filter. The secondary pool filter device eliminates the need for manual collection of dirt, debris, and other particles that escape primary filters.

A secondary pool filter device is disclosed herein. The secondary pool filter device includes a secondary filter configured to fit over and removably attach to a return jet of a swimming pool and provide secondary filtration for swimming pools. The secondary filter includes a filter pad and a filter sleeve. The filter pad encases a mesh screen and includes a plurality of layers of filtering material. The filter sleeve includes an open end and a closed end. The open end is configured to receive the filter pad for hosting the filter pad within the filter sleeve. The mesh screen may comprise a rectangular profile and a series of evenly spaced apertures. The mesh screen preferably comprises a plastic material and is pliable allowing for the filter pad to be folded and rolled into a cylindrical, rolled-condition.

The plurality of layers of filtering material of the filter pad preferably include an inner-lining and an outer-lining. The inner-lining may comprise a cotton lining and the outer-lining may comprise a felt lining. The mesh screen is encased within the inner-lining and the outer-lining. The filter sleeve may be comprised of a polyester material and the open end of the filter sleeve features a cinch tie. The filter sleeve may be secured around the filter pad for an assembled condition. The filter sleeve may be placed over a return jet within an aboveground pool, and the cinch tie may be used to secure the filter sleeve to the return jet. Additionally, the secondary pool filter device may be fastened to a pool vacuum.

According to one embodiment, the secondary pool filter device may be arranged as a kit. In particular, the secondary pool filter device may further include a set of instructions. The instructions may detail functional relationships in relation to the structure of the secondary pool filter device such that the secondary pool filter device can be used, maintained, or the like, in a preferred manner.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a secondary pool filter device, constructed and operative according to the teachings of the present disclosure.

FIG. 1 is a top perspective view of the secondary pool filter device during an ‘in-use’ condition, according to an embodiment of the disclosure.

FIG. 2 is a perspective view of a secondary filter of the secondary pool filter device of FIG. 1 including a filter pad and a filter sleeve, according to an embodiment of the present disclosure.

FIG. 3 is a perspective view of the filter pad and the filter sleeve of the secondary pool filter device of FIG. 1, according to an embodiment of the present disclosure.

FIG. 4 is a perspective view of the secondary pool filter device of FIG. 1, according to an embodiment of the present disclosure.

FIG. 5 is a perspective view of the secondary pool filter device of FIG. 1, according to an embodiment of the present disclosure.

FIG. 6 is a flow diagram illustrating a method of use, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a pool water filter device and more particularly to a secondary pool filter device as used to improve the filtration of pools. The secondary pool filter device is configured to capture any dirt, debris, particles, algae, bacteria, and pathogens that are not trapped by a primary pump filter.

Generally, the secondary pool filter device is a secondary water filter that attaches to water jets of above-ground pools. As water moves through the primary pump filter of a swimming pool and then back to the pool through the water jets, the secondary pool filter device captures any dirt, debris, particles, algae, bacteria, and pathogens that were not trapped by the primary pump filter. This additional filtration provides improved water cleansing that is of recognized need, reducing the frequency in which manual cleaning of a swimming pool is required, and saves in both time and cost of such manual cleaning. The secondary pool filter device captures dirt, debris, and other particles that bypass filtration by a primary filter of a swimming pool water pump. The secondary pool filter device helps swimming pools maintain a pleasant, recreational image and use.

The secondary pool filter device comprises a mesh screen, a filter pad and a filter sleeve. The filter pad of the device consists of an interior layer of cotton encased withing a felt fabric. The meshed screen is completely encased within the filter pad. The filter sleeve may be comprised of a polyester material and the open end of the sleeve features a cinch tie. The filter sleeve may be secured around the filter pad during an assembled condition. The filter sleeve may be placed over a return jet within an aboveground pool, and the cinch tie is used to secure the filter sleeve to the return jet. Additionally, the device may be fastened to a pool vacuum. The secondary pool filter device may be reusable and can be easily washed to remove any substances trapped within the filter pad and filter sleeve. The secondary pool filter device makes swimming pool water cleaner than is ordinarily achieved by current filtration systems. The secondary pool filter device eliminates the time and labor cost of manual collection of dirt, debris, and other particles that escape primary filters. Additionally, the secondary pool filter device can help prevent growth of algae on swimming pool walls and floors.

In a most preferred embodiment, the mesh screen of the secondary pool filter device is made of polyvinylidene fluoride (PVDF). Molded in a rectangular shape with evenly spaced apertures through its structure, the mesh screen measures approximately thirteen and one-half inches in length by seven and one-half inches in width by a sixteenth of an inch in thickness (13½″×7½″× 1/16″). The mesh screen is encased within a filter pad preferably comprising two-layers. The filter pad is approximately fourteen inches in length by eight inches in width, and approximately one-quarter of inch thick (14″×8″×¼). The inner-lining of the filter pad is made of cotton foam material contained within an outer-lining of felt. For containment of the filter pad is a filter sleeve with one (1) closed end, measuring approximately nine inches in length by six inches in width by two inches in depth (9″×6″×2″). A securing cinch tie is featured at the open end of the filter sleeve. The filter sleeve also provides additional filtering capabilities.

A method of use may be as follows: a user may roll the filter pad of the secondary pool filter device into a cylinder, and then place the filter pad within the filter sleeve. The cinch tie (or other suitable means) from the filter sleeve may then be used to secure the secondary pool filter device over a return jet of an above-ground swimming pool. After application, the secondary pool filter device provides additional filtering when water is returned to a swimming pool. With this additional filtration, all undesirable dirt, debris, and particles that were not removed by the primary filter will be kept from returning to the water, and so will algae along with many bacteria and pathogens. As a result of this secondary filtration, the user of the secondary pool filter device will not have to manually clean the pool as often, and will not have to purchase pool-cleaning materials as often, too.

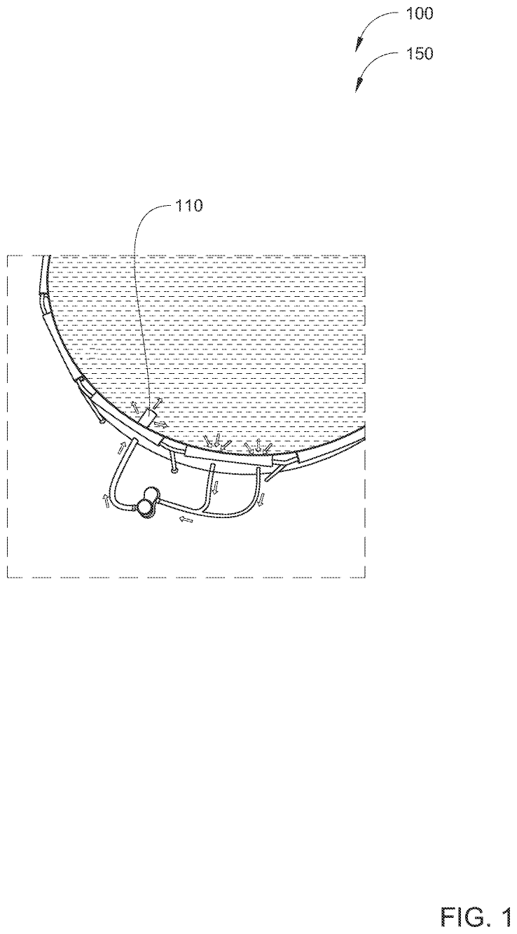

Referring now more specifically to the drawings by numerals of reference, there is shown in FIGS. 1-5, various views of a secondary pool filter device 100.

FIG. 1 shows a secondary pool filter device 100 during an ‘in-use’ condition 150, according to an embodiment of the present disclosure. As illustrated, the secondary pool filter device 100 may include a secondary filter 110 configured to fit over and removably attach to a return jet 10 of a swimming pool and provide secondary filtration for swimming pools. The secondary filter 110 comprises a filter pad 112 and a filter sleeve 130. The filter pad 112 encases a mesh screen 114 and includes a plurality of layers of filtering material. The filter sleeve 130 includes an open end 132 and a closed end 134. The open end 132 is configured to receive and host the filter pad 112. The secondary pool filter device 100 filters water flowing from the return jet 10 to which is attached. The secondary pool filter device 100 provides additional filtration of water in swimming pools, hot tubs and the like.

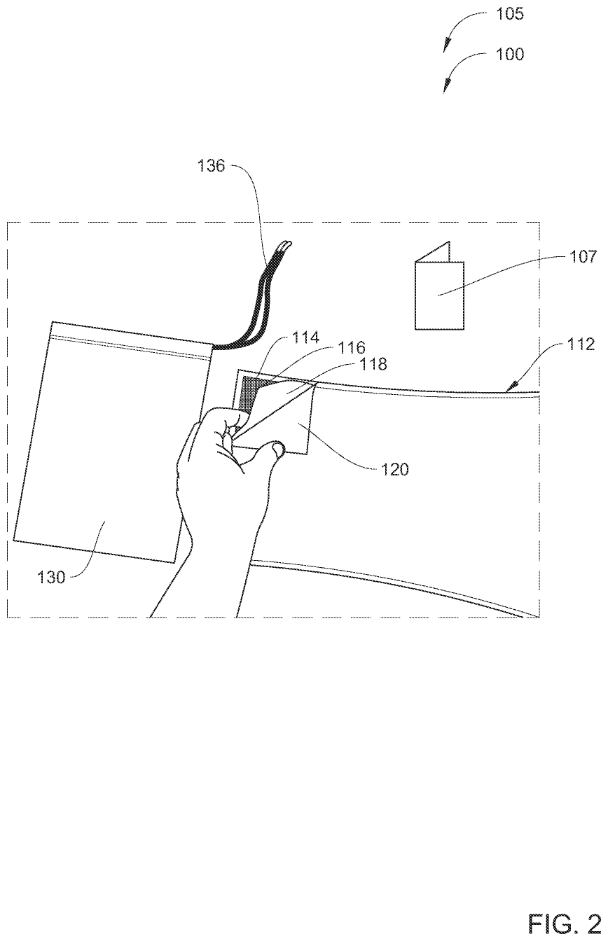

FIG. 2 shows the secondary pool filter device 100 of FIG. 1, according to an embodiment of the present disclosure. According to one embodiment, the secondary pool filter device 100 may be arranged as a kit 105. In particular, the secondary pool filter device 100 may further include a set of instructions 107. The instructions 107 may detail functional relationships in relation to the structure of the secondary pool filter device 100 such that the secondary pool filter device 100 can be used, maintained, or the like, in a preferred manner.

As shown, the filter pad 112 encases the mesh screen 114 and includes the plurality of layers of filtering material. The mesh screen 114 comprises a rectangular profile and a series of evenly spaced apertures 116 allowing water to flow therethrough and restrict larger particles from passing therethrough. The mesh screen 114 may comprise a plastic material and is pliable allowing for the filter pad 112 to be folded and rolled into a cylindrical, rolled-condition. The plurality of layers of filtering material of the filter pad 112 include an inner-lining 118 and an outer-lining 120. The inner-lining 118 preferably comprises a cotton lining and the outer-lining 120 comprises a felt lining. The mesh screen 114 is encased within the inner-lining 118 and the outer-lining 120. The mesh screen 114 may or may not be removable from the filter pad 112. In a removable variation, the mesh screen 114 may be removable from one edge of the filter pad 112. The filter pad 112 may be releasably sealable by hook-and-loop material, snaps, buttons, and/or ties. The secondary pool filter device 100 may be made in variations that include materials that provide additional filtering, such as but not limited to activated charcoal.

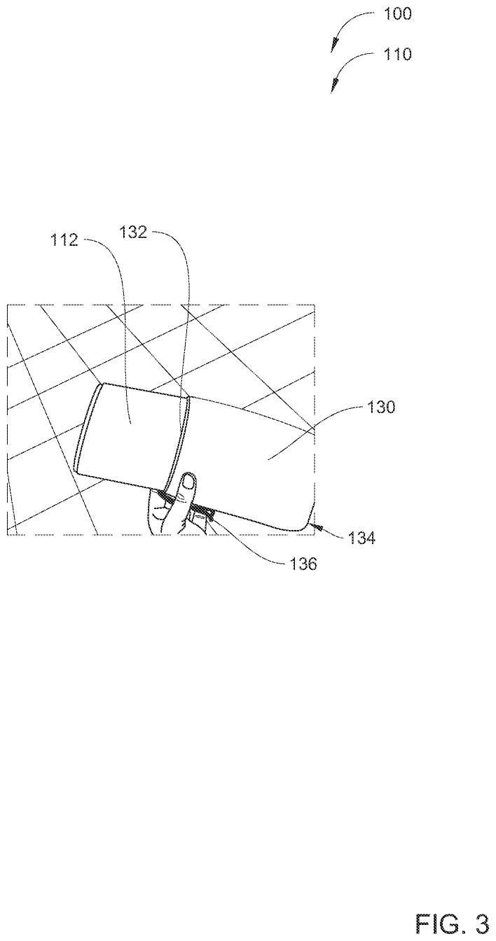

FIG. 3 is a perspective view of the filter pad 112 and the filter sleeve 130 of the secondary pool filter device 100 of FIG. 1, according to an embodiment of the present disclosure. The secondary pool filter device 100 captures dirt, debris, and other particles that bypass filtration by a primary filter of a swimming pool water pump. As above, the secondary pool filter device 100 may include the secondary filter 110 comprising the filter pad 112 and the filter sleeve 130. The filter sleeve 130 is sized and configured to receive and host the filter pad 112 when the filter pad 112 is in a cylindrical, rolled-condition. The filter sleeve 130 includes a cinch tie 136 at the open end 132 for removably securing the secondary filter 110 to one of the return jets 10 of a swimming pool, jacuzzi, or the like. The filter sleeve 130 may also be configured to be attached to a pool vacuum to provide additional filtering of pool water. The secondary pool filter device 100 may be made in variations for use with spa jets, hot tubs, and Jacuzzis. Additionally, the secondary pool filter device 100 can be made in variations for use with saltwater systems, built-in swimming pools, and other swimming pool like structures.

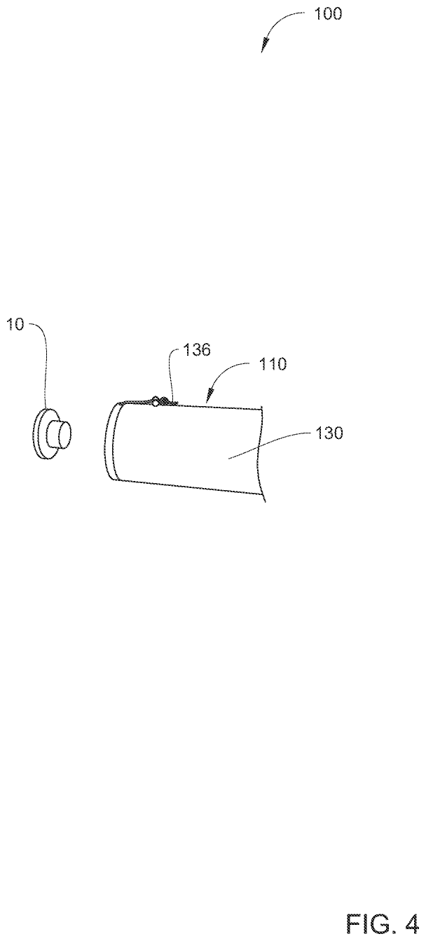

FIG. 4 is a perspective view of the secondary pool filter device 100 of FIG. 1, according to an embodiment of the present disclosure. The secondary pool filter device 100 comprises the filter pad 112 and the filter sleeve 130. The filter pad 112 is removable from the filter sleeve 130 and replaceable. The filter pad 112 and/or filter sleeve 130 of the secondary pool filter device 100 may be produced in disposable formats that are only usable for a limited time and/or limited number of washes. The mesh screen 114 of the secondary pool filter device 100 may be made of, and/or coated with, various materials of adequate chemical resistance, such as but not limited to polyvinylidene fluoride (PVDF), polydicyclopentadiene (PDCPD), polytetrafluorethylene (PTFE), acrylonitrile butadiene styrene (abs) as well as various metal materials. The inner-lining 118 of the filter pad 112 of the secondary pool filter device 100 may be made of various applicable materials, including but not limited to cotton, woven polyester, viscoelastic polyether foam, nylon, rayon, and any blend of these and other materials. The outer-lining 120 of the filter pad 112 of the secondary pool filter device 100 may be made of various applicable materials, including but not limited to natural felt, synthetic felt, woven polyester, nylon, and any blend of these and other materials. The filter sleeve 130 of the secondary pool filter device 100 may be made of various applicable materials, including but not limited to cotton blends, woven polyester, nylon, and any blend of these and other materials.

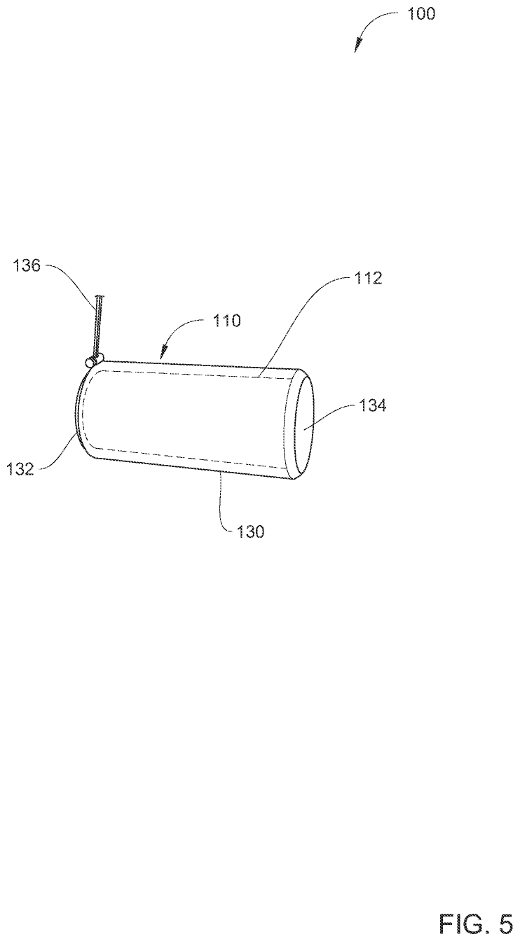

FIG. 5 is a perspective view of the secondary pool filter device 100 of FIG. 1, according to an embodiment of the present disclosure. In a preferred embodiment, the filter pad 112 comprises a length of approximately fourteen inches and a width of approximately eight inches. The mesh screen 114 comprises a screen-length of approximately thirteen and one-half inches, a screen-width of approximately seven and one-half inches, and a thickness of approximately a sixteenth of an inch. The secondary pool filter device 100 may be made in various sizes, shapes and colors. The secondary pool filter device 100 may be made in variations of size and material for use with any size outdoor swimming pool water pump system.

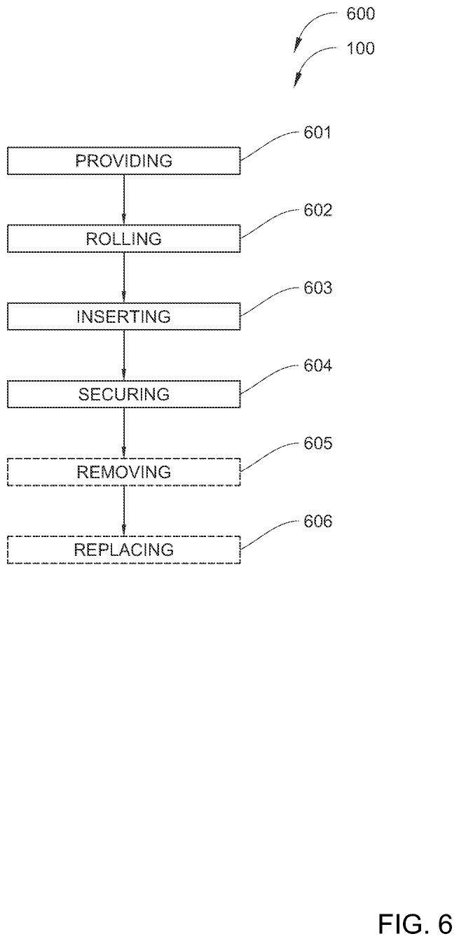

FIG. 6 is a flow diagram illustrating a method of using a secondary pool filter device 600, according to an embodiment of the present disclosure. In particular, the method of using a secondary pool filter device 600 may include one or more components or features of the secondary pool filter device 100 as described above. As illustrated, the method of using a secondary pool filter device 600 may include the steps of: step one 601, providing a secondary filter 110 configured to fit over and removably attach to a return jet 10 of a pool; the secondary filter 110 comprising a filter pad 112 encasing a mesh screen 114 and including a plurality of layers of filtering material, a filter sleeve 130 having an open end 132 configured to receive and host the filter pad 112 and a closed end 134; step two 602, rolling the filter pad 112 into a cylindrical configuration; step three 603, inserting the filter pad 112 into the filter sleeve 130; step four 604, securing the filter sleeve 130 containing the filter pad 112 to the return jet 10; step five 605, removing the secondary filter 110; and step six 606, replacing the filter pad 112.

It should be noted that step five 605 and step six 606 are optional steps and may not be implemented in all cases. Optional steps of method of use 600 are illustrated using dotted lines in FIG. 6 so as to distinguish them from the other steps of method of use 600. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of using a secondary pool filter device, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A secondary pool filter device, the secondary pool filter device comprising:
a secondary filter configured to fit over and removably attach to a return jet of a pool, said secondary filter comprising,
a filter pad encasing a mesh screen and including a plurality of layers of filtering material, and
a filter sleeve having an open end configured to receive and host said filter pad and a closed end.

2. The secondary pool filter device of claim 1, wherein said filter sleeve comprises a generally cylindrical profile.

3. The secondary pool filter device of claim 1, wherein said filter sleeve includes a cinch tie at said open end for removably securing said secondary filter to one of said return jets.

4. The secondary pool filter device of claim 3, wherein said filter sleeve is sized and configured to receive and host said filter pad when said filter pad is in a cylindrical, rolled-condition.

5. The secondary pool filter device of claim 1, wherein said mesh screen comprises a series of evenly spaced apertures.

6. The secondary pool filter device of claim 5, wherein said mesh screen is pliable.

7. The secondary pool filter device of claim 6, wherein said mesh screen comprises a rectangular profile.

8. The secondary pool filter device of claim 7, wherein said mesh screen comprises a plastic material.

9. The secondary pool filter device of claim 1, wherein said plurality of layers of filtering material of said filter pad include an inner-lining and an outer-lining.

10. The secondary pool filter device of claim 9, wherein said inner-lining comprises a cotton lining and said outer-lining comprises a felt lining.

11. The secondary pool filter device of claim 10, wherein said mesh screen is encased within said inner-lining and said outer-lining.

12. The secondary pool filter device of claim 1, wherein said filter sleeve comprises a polyester material.

13. The secondary pool filter device of claim 1, wherein said filter pad is removable from said filter sleeve and replaceable.

14. The secondary pool filter device of claim 1, wherein said filter pad comprises a length of approximately fourteen inches and a width of approximately eight inches.

15. The secondary pool filter device of claim 14, wherein said mesh screen comprises a screen-length of approximately thirteen and one-half inches, a screen-width of approximately seven and one-half inches, and a thickness of approximately a sixteenth of an inch.

16. The secondary pool filter device of claim 1, wherein said secondary filter is further configured to removably attach to a pool vacuum.

17. A secondary pool filter device, the secondary pool filter device comprising:
a secondary filter configured to fit over and removably attach to a return jet of a pool, said secondary filter comprising,
a filter pad encasing a mesh screen and including a plurality of layers of filtering material,
a filter sleeve having an open end configured to receive and host said filter pad and a closed end;
wherein said filter sleeve comprises a generally cylindrical profile;
wherein said filter sleeve includes a cinch tie at said open end for removably securing said secondary filter to one of said return jets;
wherein said filter sleeve is sized and configured to receive and host said filter pad when said filter pad is in a cylindrical, rolled-condition;
wherein said mesh screen comprises a series of evenly spaced apertures;
wherein said mesh screen is pliable;
wherein said mesh screen comprises a rectangular profile;
wherein said mesh screen comprises a plastic material;
wherein said plurality of layers of filtering material of said filter pad include an inner-lining and an outer-lining;
wherein said inner-lining comprises a cotton lining and said outer-lining comprises a felt lining;
wherein said mesh screen is encased within said inner-lining and said outer-lining;
wherein said filter sleeve comprises a polyester material;
wherein said filter pad is removable from said filter sleeve and replaceable;
wherein said filter pad comprises a length of approximately fourteen inches and a width of approximately eight inches;
wherein said mesh screen comprises a screen-length of approximately thirteen and one-half inches, a screen-width of approximately seven and one-half inches, and a thickness of approximately a sixteenth of an inch; and
wherein said secondary filter is further configured to removably attach to a pool vacuum.

18. The secondary pool filter device of claim 17, further comprising set of instructions; and
wherein the secondary pool filter device is arranged as a kit.

19. A method of using a secondary pool filter device, the method comprising the steps of:
providing a secondary filter configured to fit over and removably attach to a return jet of a pool, the secondary filter comprising a filter pad encasing a mesh screen and including a plurality of layers of filtering material, a filter sleeve having an open end configured to receive and host the filter pad and a closed end;
rolling said filter pad into a cylindrical configuration;
inserting said filter pad into said filter sleeve; and
securing said filter sleeve containing said filter pad to said return jet.

20. The method of claim 19, further comprising the steps of:
removing said secondary filter; and
replacing said filter pad.
